(19) United States
(12) Patent Application Publication
(10) Pub. No.: US 2011/0273965 A1
(43) Pub. Date: Nov. 10, 2011

(54) DEVICE AND METHOD FOR TRANSMITTING INFORMATION IN SOLID MEDIA

(75) Inventors: Peter-Michael Mayer, Stuttgart (DE); Frank Schmidt, Altkirchen (DE)

(73) Assignee: EnOcean GmbH

(21) Appl. No.: 12/937,686

(22) PCT Filed: Apr. 11, 2009
(86) PCT No.: PCT/EP2009/002696

§ 371 Date: May 26, 2011

(30) Foreign Application Priority Data
Apr. 14, 2008 (DE) 10 2008 001 160.6
Apr. 15, 2008 (DE) 10 2008 001 189.4

(51) Int. Cl. H04B 11/00; H04B 13/00

(52) U.S. Cl. 367/137

(57) ABSTRACT

The invention relates to a device for transmitting information in solid media (21) with at least one communication node (1, 33), comprising a transmission device and a receiving device. To improve the information transmission, the transmission device comprises at least one transmitter with a converter for converting electric information into mechanical waves. The receiving device comprises at least one receiver with a convener for converting mechanical waves into electric information. The transmitter and the receiver are in mechanical contact to a solid medium (21).

The invention relates to a device for the transmission of information in solid media of the class specified in the preamble of Claim 1, as well as to a method according to the preamble of Claim 23.

Information is transmitted in different ways, wherein it is considered whether the information transmission is to be performed through a gaseous, liquid, or solid medium. In gaseous media, information is often transmitted by electromagnetic radio waves. The information transmission by means of radio waves in solid media is, for the most part, not possible at all or at best only to a very limited degree due to the high attenuation of these waves. Therefore, in solid media the information transmission usually takes place through electrical or optical conductors.

From the animal kingdom it is known that, e.g., deathwatch beetles (anobiidae, furniture beetles) communicate with each other by means of acoustic signals, i.e., surface acoustic waves (Rayleigh waves). From mine construction it is known that, in the scope of the development of rescue methods, the acoustically induced positioning has been studied; however, this has turned out to be very difficult, because the transmission function of the soil with recently collapsed hollow spaces greatly alienates the signals.

The present invention forms the basis of the task to create a device for the transmission of information in solid media of the type according to the class, wherein the information transmission is improved with this device. In addition, the task of the invention is to disclose a method for the transmission of information in solid media of the type named above that is simple and functionally safe.

These tasks are achieved by a device with the features of Claim 1 and by a method with the features of Claim 23. In this connection, mechanical waves are the mechanical oscillations and waves of an elastic medium that are also designated as sound waves.

Here, a coupling of a source or a transmitter to the solid medium, the transmission of the signal through the solid body, as well as its reception and identification are essential. The transmission of elastic waves through solid media whose structure, condition, properties, and state are known can be quantified in that a transmission function for the solid medium is calculated. For geological formations, the solid medium is usually not known; therefore, transmission functions are to be calculated or calibration processes are to be performed, as well as the signals are to be identified uniquely.

Through the present invention, information can be transmitted with the help of mechanical waves completely or partially within solid media, such as, for example, through the ground, through rock formations, through underground constructions and storage facilities, dams, tunnels, and buildings. Here, “completely” means that the transmission of the information is performed exclusively through solid media as so-called structure-borne sound and “partially” means that the information transmission also takes place, in part, through liquid media or gaseous media, such as, e.g., water or air.

According to a preferred refinement of the device according to the invention, a sequence-control module comprises a programmable microcontroller that performs the sequence control with the help of the software and contains memory circuits. In addition, it is advantageous that the sequence control module comprises a memory in which an identification number is stored that maps to the identity of the respective communications node. Furthermore, the sequence control module is preferably provided with at least one input and output, in order to input corresponding information for the sequence control or to output from this control. So that both analog and also digital data can be processed, the sequence control module has an analog/digital converter. It is also advantageous that the sequence control module comprises a timer for the control of a time sequence through which, in activity pauses of the communications node, an especially low energy consumption can be set. This is important especially for communications nodes that are operated with limited energy resources.

According to one embodiment of the device, the communications node is provided with a connection device for a supply line of electrical energy, e.g., through a power-supply network. Alternatively, an advantageous construction provides that the communications node is equipped with a local electrical energy source, wherein this is a storage device. For this purpose, accumulators, batteries, as well as also other electrochemical storage devices could be used, likewise nuclear or capacitive storage devices. In another alternative construction, the communications node has an energy converter that converts available ambient energy into electrical energy. This could involve, for example, thermal energy, vibrations, flowing water or gas, or radioactive radiation.

As converters of the flow of electrical information into mechanical waves, sound converters could be used that operate according to the electromagnetic, electrostatic, magnetostrictive, or piezoelectric principle. It is also advantageous that the transmitting device and/or the receiving device comprises an electronic amplifier. In the transmitting device, this amplifier causes a power amplification of the flow of information issued from the sequence control and an impedance matching to an electroacoustic converter. The information to be transmitted is coded, e.g., analogous to the Morse principle. The signal form is known either in the frequency domain or with respect to the time length. Good coupling is important in order to optimize the signal/noise ratio.

Preferably, the transmitting device and/or the receiving device has filters, for example, correlation filters or band-pass filters. Matched filters could realize a correlation of the transmitting and receiving signals and could in this way fight acoustic noise and high attenuation. By means of band-pass filters in the receiving device, the quality of the signal recognition is improved. Here, ambient noise is also to be heeded, for example, noise made by vehicles, machines, or geological activities, which could have a disruptive effect. The disruptive signals are suppressed with the mentioned filters.

In another construction of the invention, the communications node has an interface for the connection of a wired bus system. This is important for so-called end nodes that are arranged at the border to other media, e.g., water or air or close to the border. It is likewise advantageous that such end nodes provide components for radio communications, so that the data can be transmitted by radio waves.

In addition it is useful to provide the communications node with at least one sensor, wherein multiple sensors provide the opportunity of capturing different parameters. Here, it could involve ambient parameters, such as temperature, pressure forces, or position, or parameters of the communications node itself, such as, e.g., energy status or internal temperature. This information can be transmitted by means of the mechanical waves and can be forwarded optionally from end nodes also by means of radio waves. In another construction, at least one actuator, advantageously multiple actuators are provided that are connected directly or indirectly to the communications node. The communications nodes can control these actuators automatically or as a function of exchanged information. Examples for such actuators are valves, switches, relays, motors, etc.

The linking of multiple communications nodes into networks that can hand over the information via multiple stations is advantageous, wherein higher ranges are achieved. Furthermore, redundant information paths could be realized, which lead to a higher transmission reliability. Finally, a spatial or planar monitoring of spread-out structures is possible in this way, likewise resulting in an increased redundancy and reliability of the information retrieval. In particular, a device of self-organizing networks in which the flow of information is not set permanently is advantageous, but instead is calculated according to the respective propagation conditions of the communications nodes. Optimum communications paths could also be managed dynamically, that is, they are regularly checked and optionally set up again. This is advantageous for changing ambient conditions, e.g., movements, the influence of changing water levels, etc., and also for the loss of individual communications nodes in a network.

The signal transmission in the method according to the invention is a transmission and identification of signals through solid rock, another solid or, in part, solid media. Through the elastic properties of the medium, the signal is scattered, damped, etc., during its wave propagation. This can be described with a transmission function calculated by tests and can be compensated computationally.

An additional improvement of the signal/noise ratio can be achieved through the method of stacking that is common in seismic technology, i.e., the expected signals are received multiple times and placed one on top of the other. Here, there is the possibility to provide multiple receivers, which is not problematic with respect to the power supply. In addition, processing technology for multiple receivers could be applied. As an alternative or addition to the construction with multiple receivers, there is furthermore the possibility to transmit the signal multiple times, by means of which temporary noise is removed.

According to a preferred refinement of the method according to the invention, the sequence control of the operating states of the communications node, such as transmitting mode, receiving mode, measurement-value collection, timer status, ready for use, etc., is performed with the help of a sequence control module that preferably comprises a programmable microcontroller. In the transmitting device, with the help of a converter, electrical information is converted into mechanical waves and coupled with the help of a transmitter into the solid medium. For this purpose, a mechanical contact of the transmitter with the solid medium is required.

Furthermore, it is advantageous if the communications between communications nodes is performed such that information is modulated on the mechanical wave used as a carrier wave. For this purpose, in the transmitter, the amplitude or the frequency or the phase or a mixed form of these is influenced at the rate of the flow of information. Here, both digital and also analog modulation methods are possible. In addition, it is preferable that, in the receiving device, a flow of information modulated onto a carrier wave is separated with the help of a demodulator and is converted into a digital or analog data flow.

A simple form for modulating information is given in the use of a Morse code. This is advantageous because a Morse code is simple to code and decode. Here, the use of frequency modulation or amplitude modulation is possible. As a simple form of amplitude modulation, only one pulse needs to be transmitted and received. If the time intervals between the pulses are selected long enough, problems with code phases (conversions, reflections, etc.) are avoided.

The invention will be explained in detail below with reference to embodiments. Shown in the drawing are:

FIG. 1, in schematic diagram, the construction of a communications node;

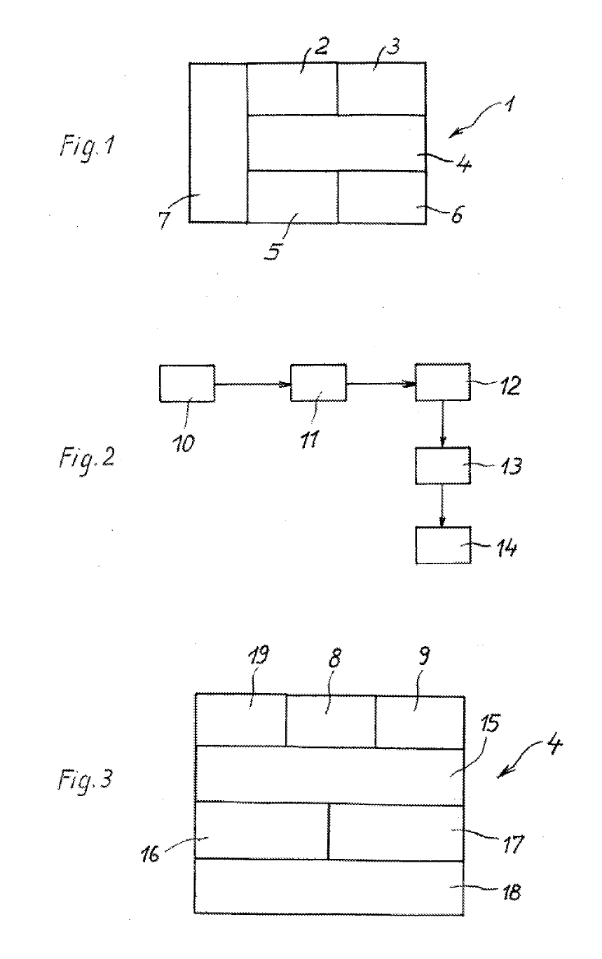

FIG. 2, a flowchart for the energy production;

FIG. 3, in schematic diagram, the components of a sequence control module;

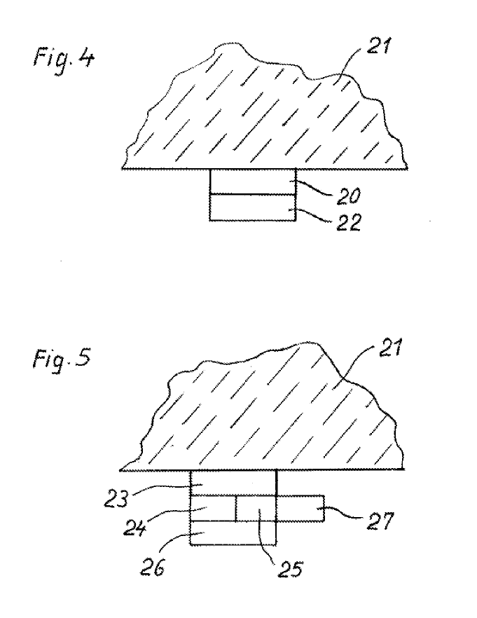

FIG. 4, a transmitter in mechanical contact with a solid medium;

FIG. 5, a receiver in mechanical contact with a solid medium;

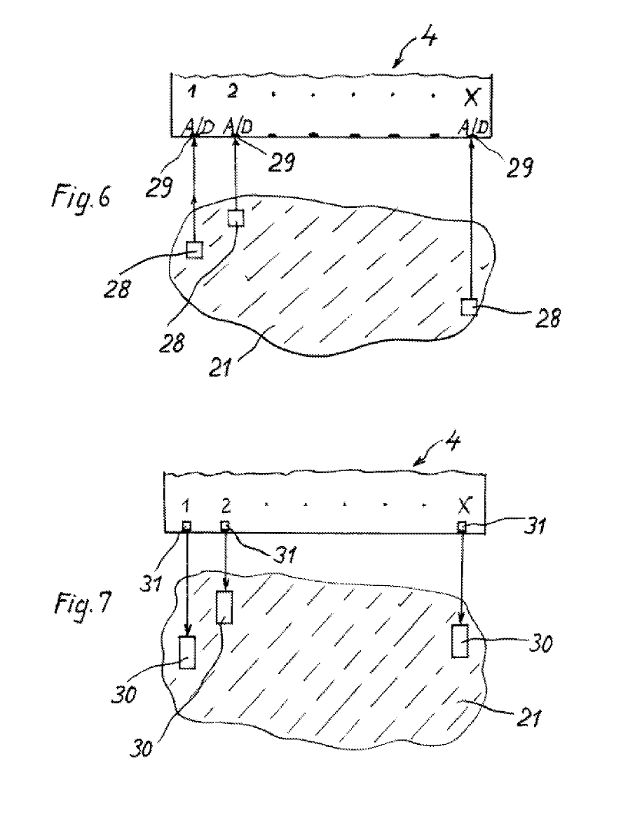

FIG. 6, sensors in the environment of the communications node;

FIG. 7, actuators in the environment of the communications node;

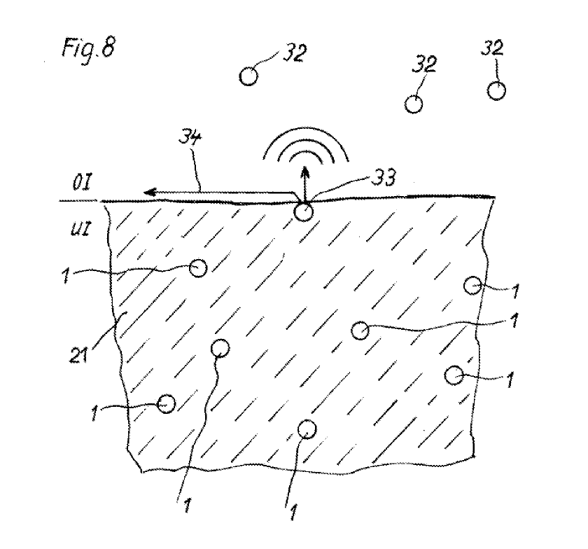

FIG. 8, a network formed from multiple communications nodes.

In FIG. 1, the construction of a communications node 1 is shown that comprises a transmitting device 2, a receiving device 3, and a sequence control module 4. Furthermore, sensors 5 and actuators 6 are provided that could also be arranged in the environment of the communications node 1. An energy source 7 that could be distinguished according to the planned positioning of the communications node 1 also belongs to the communications node 1. Thus, for example, it is possible to provide the communications node 1 with a connection device for a supply line of electrical energy, so that the energy could be drawn from a power grid. Alternatively, local electrical energy sources are also possible, wherein such an energy source is a storage device. For this purpose, accumulators, batteries, as well as also other electrochemical storage devices could be used, likewise nuclear or capacitive storage devices. Another alternative consists in that the communications node has an energy converter that converts available ambient energy into electrical energy. Here, it could involve, for example, thermal energy, vibrations, flowing water or gas, or radioactive radiation. If a high power demand is to be expected temporarily or for the case that phases appear with low or no ambient energy, additional storage devices, e.g., capacitors or accumulators could be provided, in order to ensure the power supply to the communications nodes.

FIG. 2 shows a flowchart for the energy production. The reference symbol 10 designates the energy source that is connected to a converter 11 for conversion into electrical energy. The electrical energy is fed to an electrical storage device 12 that is also used as a buffer, in order to compensate for fluctuations in the supplied energy. From the storage device 12, the electrical energy is fed to a voltage converter 13 after which a constant supply voltage 14 is then made available.

In FIG. 3, the components of the sequence control module 4 are shown that comprises inputs 8 and outputs 9. For the sequence control, a microcontroller 15 is used with a storage device 16 and a software program 17. In addition, a timer 18 is provided through which, in activity pauses of the communications node, an especially low energy demand is adjustable. Furthermore, the sequence control module 4 comprises an analog/digital converter 19, so that both analog and also digital data can be processed.

FIG. 4 shows a transmitter 20 that is a component of the transmitting unit 2 named in FIG. 1, in mechanical contact with a solid medium 21. The transmitter 20 comprises an electroacoustic converter to which a power amplifier 22 is allocated that causes a power amplification of the flow of information issued from the sequence control and an impedance matching to the electroacoustic converter. In the transmitter 20, information is modulated onto the mechanical waves, e.g., by means of amplitude modulation with the Morse-coded information.

FIG. 5 shows a receiver 23 that is a component of the receiving device 3 named in FIG. 1 and is in mechanical contact with the solid medium 21. The receiver 23 comprises an electroacoustic converter. In the embodiment, an amplifier 24 and a filter 25 are provided, wherein the filter improves the signal/noise ratio. This can be useful for achieving long ranges, as well as for overcoming acoustic disturbances. Furthermore, a demodulator 26 is present through which a flow of information modulated onto a carrier wave is separated and is converted into a data flow.

In addition, in FIG. 5 an alarm device 27 is also provided that is suitable for the issuing of alarm calls. These alarm calls are defined signals that move a communications node from an especially current-saving mode into full reception or operation readiness. These signals are suitable exclusively for the transmission of a single or a few alarm commands. The sense of this device is to keep the communications node, for the most part, in an energy-saving mode and to activate it only when needed. An improvement in the signal/noise ratio can be achieved through the connection of multiple receivers to form an array. Here, a good coupling to the solid medium is also important, in order to optimize the signal/noise ratio, wherein the transmission function of the receiver is known. For this purpose, the technology known, for example, as a micro-electrical-mechanical system, can be used.

The receiving and transmitting devices can be combined into one device. It is also possible to construct communications nodes so that they operate unidirectionally, wherein, in this case, they must have only one transmitter or one receiver. Alternatively, the communications nodes could be constructed so that they operate bidirectionally, for which, however, they require a transmitter and a receiver.

FIG. 6 shows sensors 28 that are arranged in the solid medium 21 in an environment of the communications node. The sensors 28 are each connected to inputs 29 of the analog/digital converter 19 specified in FIG. 3 and are thus connected to the sequence control module 4. These sensors 28 are provided in the environment of the communications node for the detecting of environment parameters, for example, mechanical stress, temperature, vibrations, radioactive radiation, movements, water content, flow rates, etc. The number of sensors 28 can be defined according to the parameters to be detected.

In FIG. 7, actuators 30 are shown that are arranged in the solid medium 21 in the environment of the communications node and can be connected directly or indirectly to outputs 31 of the sequence control module 4 or the communications node. As the actuators, for example, valves, switches, relays, and motors could be used.

FIG. 8 shows a network that is made from a plurality of communications nodes 1 in the solid medium 21 as well as communications nodes 32 located outside of the solid medium. The region of the solid medium is designated with UI and the region lying above with OI. The region OI is aboveground, so that a boundary is formed at the transition from the solid medium 21 to the aboveground medium “air,” with a communications node constructed as the end node 33 being arranged at the boundary. This end node 33 is also provided with a connection of a wired bus system 34 and is equipped with components for radio communications or optical communications with the communications node 32.

Advantageously, the communications nodes 1, 33 are designed so that a wideband range of oscillation frequencies can be emitted and received. This wideband characteristic allows an optimization of the transmission for different environmental media, such as sand, concrete, water, clay, etc. Advantageously, the communications nodes 1, 33 are in the position to automatically determine the optimal transmission window and to adapt to each other. The possibility of the wideband information transmission also represents the basis for numerous methods with which properties of the transmission method can be optimized. Examples for wideband methods are correlation methods, as well as the pulse compression or the transmission of frequency shifts that then lead in the receiver for the application of matching processing methods to an improvement of the signal/noise ratio and thus to more transmission reliability and longer ranges.

Advantageously, the operation of the communications nodes is cyclical, so that short phases of activity, such as transmission, data collection, and reception alternate through long phases of rest. The change from rest phases to active phases can be realized in a way controlled by the timer, wherein sequences that are synchronized in time in networks could be required. Asynchronous methods are also advantageous, in particular, according to the following stipulations:

at least one communications node is permanently ready for reception and records all incoming signals,

all other communications nodes are active asynchronously and then communicate with the always active communications node.

Advantageously, a number of communications nodes is placed exactly where information must be collected repeatedly in solid media. Examples for this are:

Monitoring and condition measurement of constructions, such as bridges, houses, dams, tunnels, etc., on operating parameters, such as loading, traffic flow, availability, etc., as well as on changes in the running operation, as well as before and after catastrophes, such as, for example, earthquakes or terrorist attacks.

Monitoring of man-made storage facilities, such as, e.g., radioactive repositories.

Monitoring of natural resources, e.g., water, crude oil, natural gas, methane deposits on the sea floor.

Monitoring of geological formations, e.g., for earthquake prediction.

Monitoring of land and water for human activities that can be registered by sound or other measurement parameters, e.g., vehicles, troop movements, ships, etc.

Monitoring of pipelines or cables in the ground.

1. Device for the transmission of information in solid media with at least one communications node that comprises a transmitting device and/or a receiving device, characterized in that the transmitting device has at least one transmitter with a converter that converts electrical information into mechanical waves and the receiving device has at least one receiver with a converter that converts mechanical waves into electrical information, respectively, and that the transmitter and/or receiver are/is in a mechanical contact to a solid medium.

2-31. (canceled)
